(19) United States
(12) Patent Application Publication
(10) Pub. No.: US 2009/0106055 A1
(43) Pub. Date: Apr. 23, 2009

(54) COMPUTER NETWORK BASED UNIVERSAL RESERVATION SYSTEM

(75) Inventors: Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,444

(22) Filed: Oct. 21, 2008

Related U.S. Application Data
(60) Provisional application No. 60/981,738, filed on Oct. 22, 2007.

(51) Int. Cl. G06Q 10/00; G06Q 90/00

(52) U.S. Cl. 705/5

(57) ABSTRACT

A computer network based universal reservation system (CNBURS) that enables clients to schedule reservations for services provided by service providers. In one embodiment the CNBURS includes a single universal reservations processing center (URPC), one or more service offering systems (SOSs) and one or more marketplaces. The URPC receives service offers defined by the service offer providers. Each SOS enables service offer providers to define one or more service offers. Each marketplace system receives the service offer(s) from the URPC, presents the clients the service offer(s), receives reservation requests from the clients relating to the service offer(s), and communicates received reservation requests to the URPC. The URPC communicates the service offer(s) from the one or more SOSs to the one or more marketplace systems and processes reservation requests received from the one or more marketplace systems.

### RELATED APPLICATION INFORMATION

This application claims priority from U.S. Provisional Application Ser. No. 60/981,738, entitled “COMPUTER NETWORK BASED UNIVERSAL RESERVATION SYSTEM” filed on Oct. 22, 2007, which is incorporated by reference herein in its entirety.

### FIELD OF THE INVENTION

The present invention relates generally to facilitating the reservation of services offered by service providers, and more particularly to the reservation of services using computer network connected systems.

### BACKGROUND OF THE INVENTION

The Internet and other computer networks have proven to be a useful medium for connecting service providers with persons seeking to obtain services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In each of the foregoing examples, the scheduling function is integrated with the system that presents information about the available service. Furthermore, access to the system that presents information about the available services may be limited to particular marketplaces. For example, the doctor's office, car rental agency's, or restaurant's Web site might be accessible via a Web portal, but not via a mobile phone portal or a digital television system. Additionally, the clients seeking services may be presented with a myriad of different scheduling systems and processes in order to reserve a variety of differing services since the clients directly interface with the service offering systems.

### SUMMARY OF THE INVENTION

Accordingly, the present invention provides an information technology (IT) implementation of a computer network based universal reservation system (CNBURS). The CNBURS implementation is consistent with principles described herein and in separate United States Patent Applications filed contemporaneously herewith entitled “UNIVERSAL BUSINESS TO MEDIA RESERVATION SYSTEM” (which application claims priority from U.S. Provisional Application Ser. No. 60/981,760 filed Oct. 22, 2007) and “BUSINESS TO MEDIA RESERVATION BUSINESS PROCESS” (which application claims priority from U.S. Provisional Application Ser. No. 60/981,744 filed Oct. 22, 2007), the entire disclosures of which are incorporated by reference herein. The CNBURS allows persons to schedule reservations for services with service providers. Persons scheduling reservations may be referred to herein as clients/service buyers or simply as clients. The types of services that may be reserved using the CNBURS are unlimited.

One purpose of the present invention is to define a set of components that create/enable a CNBURS configured in a way that allows the CNBURS to achieve a number of aspects and advantages, including:
(1) provide multiple computer network enabled marketplaces and multiple analog and digital media interfaces available to clients;
(2) provide multiple computer network enabled service offering systems to service providers through multiple digital media interfaces;
(3) separate marketplaces from the universal scheduling agent;
(4) separate service offering systems from the universal scheduling agent;
(5) connect marketplaces to service providers through the universal scheduling agent;
(6) create toolkits for software developers that allow the integration of their software with the CNBURS; and
(7) make the CNBURS network topology more flexible and more efficient.

The CNBURS may include components of six different types, namely, three internal component types and three external component types. The three internal component types are a universal reservation processing center (URPC) type, a service interface broker (SIB) type, and a marketplace interface broker (MIB) type. The three external component types are a service offering system (SOS) type, a media interface type, and a marketplace system type. The CNBURS may also include two types of external application programming interfaces (APIs).

A component of the URPC type (the URPC) functions as the universal scheduling agent. The URPC manages the schedule and service data in the CNBURS. The URPC is also responsible for communication to and between SIB and MIB components.

Components of the service interface broker type (service interface brokers or SIBs) enable communication between the URPC and service offering systems.

Components of the SOS type (service offering systems or SOSs) provide the service provider(s) with the capability to define service offerings and schedule availability of the offered services, and the capability to receive reservations.

Components of the media interface type (media interfaces) present a service offering system to the service providers and present a marketplace to the clients/service buyers.

Components of the MIB type (marketplace interface brokers or MIBs) enable communication between the URPC and marketplaces and present service offerings from service offering systems to marketplace systems.

Components of the marketplace type (marketplaces) are responsible for defining a collection of service offerings to be made available to the client/service buyers.

The first type of API is between a SOS and a SIB. The first API may be referred to herein as the “services API” or SAPI. The SAPI allows software developers to create or integrate many different SOSs to the CNBURS. This interface includes a definition and delegation function that allows for the URPC to act as the universal scheduling agent.

The second type of API is between a marketplace and a MIB. The second API may be referred to herein as the “marketplace API” or MAPI. The MAPI allows software developers to create or integrate many different marketplaces to CNBURS. This interface includes a search request capability that allows the marketplace to provide possible reservations, and allows the URPC to act as the universal scheduling agent and confirm a reservation.

The present invention includes various aspects and features. In one aspect, a CNBURS that enables one or more clients to schedule reservations for services provided by one or more service providers includes a single URPC, one or more SOSs, and one or more marketplaces. The URPC is enabled to receive one or more service offers that are defined by the service offer providers. Each SOS enables service offer providers to define one or more service offers. In this regard, a defined service offer may include information indicating whether or not the URPC is delegated authority to complete reservation requests with clients relating to the service offers. Each marketplace system is enabled to receive the one or more service offers from the URPC, present the clients the one or more service offers, receive reservation requests from the clients relating to the one or more service offers, and communicate received reservation requests to the URPC. The URPC communicates the one or more service offers from the one or more SOSs to the one or more marketplace systems and processes reservation requests received from the one or more marketplace systems. The CNBURS may also include one or more SIBs, one or more MIBs, a media interface for each SOS, and a media interface for each marketplace. In the CNBURS there may also be a SAPI for each SIB and its respective SOS and a MAPI for each MIB and its respective marketplace.

In another aspect, a CNBURS that enables one or more clients to schedule reservations for services provided by one or more service providers includes a SOS that defines a service offer by a service provider, a URPC that receives the service offer, a SIB corresponding with the SOS that connects the corresponding SOS with the URPC for communication there between via a computer network, an API interfacing the corresponding SIB and SOS, and a plurality of marketplace systems. Each marketplace system receives the service offer from the URPC, presents the clients the service offer, receives reservation requests from the clients relating to the service offer, and communicates received reservation requests to the URPC. The URPC communicates the service offer from the SOS to the marketplace systems and processes reservation requests received from the marketplace systems.

In a further aspect, a CNBURS that enables one or more clients to schedule reservations for services provided by one or more service providers includes a plurality of SOSs that define one or more service offers by one or more service providers, a URPC that receives the one or more service offers, a marketplace system that receives the one or more service offers from the URPC, presents a client the one or more service offers, receives a reservation request from the client relating to the one or more service offers, and communicates the received reservation request to the URPC, a marketplace interface broker corresponding with the marketplace system that connects the corresponding marketplace system with the URPC for communication there between via a computer network, and an API interfacing the corresponding marketplace interface broker and marketplace system. The URPC communicates the one or more service offers from the SOSs to the marketplace system and processes the reservation request received from the marketplace system.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing the detailed architecture of one embodiment of a CNBURS;

FIG. 2 illustrates two possible manners of incorporating a MIB into a service offering system;

FIG. 3 illustrates two possible manners of incorporating a SIB into a marketplace system; and

FIG. 4 is a block diagram showing the architecture of one example of a computing system that may be utilized in implementing various components of the CNBURS.

### DETAILED DESCRIPTION

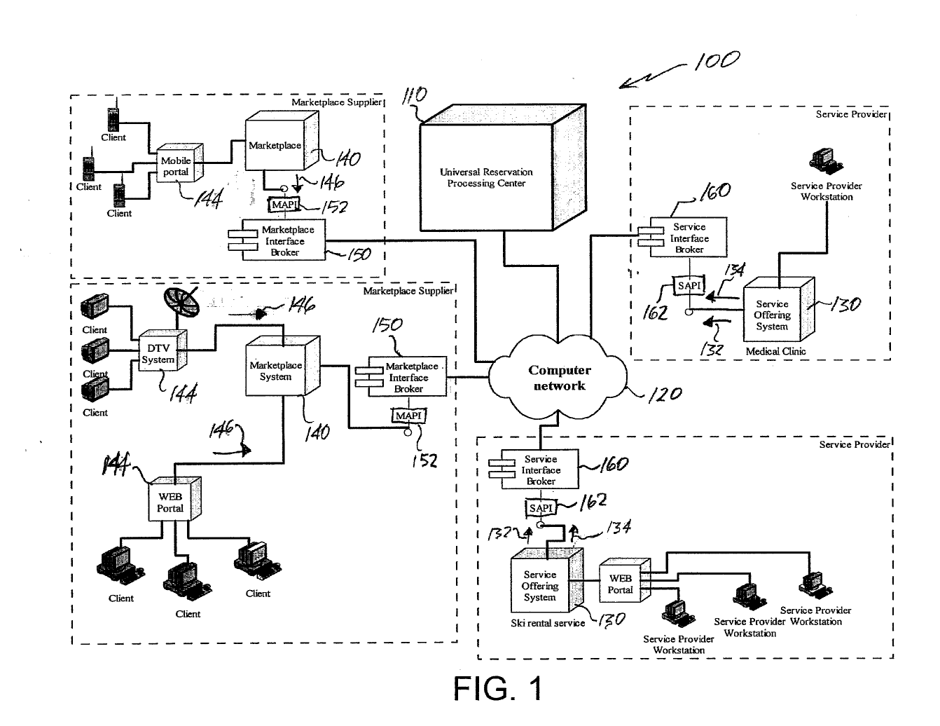

One embodiment of a CNBURS 100 architecture is shown on FIG. 1. The CNBURS 100 architecture of FIG. 1 includes one universal reservation processing centre (URPC) 110. The URPC 110 is connected to one or more computer networks 120 and communicates thereby with one or more service offering systems 130 and one or more marketplace systems 140.

The computer network(s) 120 may, in general, be any public network(s), any private networks, or any combination of public and private network(s) that provide for the communication of data among devices connected to the network(s). Examples of such network(s) include the Internet, private switched telephone networks, cellular telephone networks, cable and satellite television networks, wireless networks, frame relay channels, leased lines or the like.

Although the URPC 110 is represented by a single box in FIG. 1, the URPC 110 need not necessarily be implemented as a single computer program or a centralized system. In addition to implementing the URPC 110 as a single computer program or centralized computing system, it is also possible to implement the URPC 110 as a distributed computing system.

The marketplace systems 140 provide user interfaces for marketplaces in various media 144. Examples of such media interfaces 144 include, for example, Web Portals accessible from the Internet, Digital TV systems that provide marketplaces for TV watchers, and mobile portals.

The URPC 110 functions as a broker between the service offering system(s) 130 and the marketplace system(s) 140. The URPC 110 is responsible for retrieving a service offer 132 from a service offering system 130, maintaining a copy of the retrieved offer 132 in its internal database, and providing the offer 132 to a marketplace system 140. The URPC 110 is also responsible for accepting reservations requests 146 from a marketplace system 140, passing those requests 146 to a service offering system 130, and providing results back to the marketplace system 140.

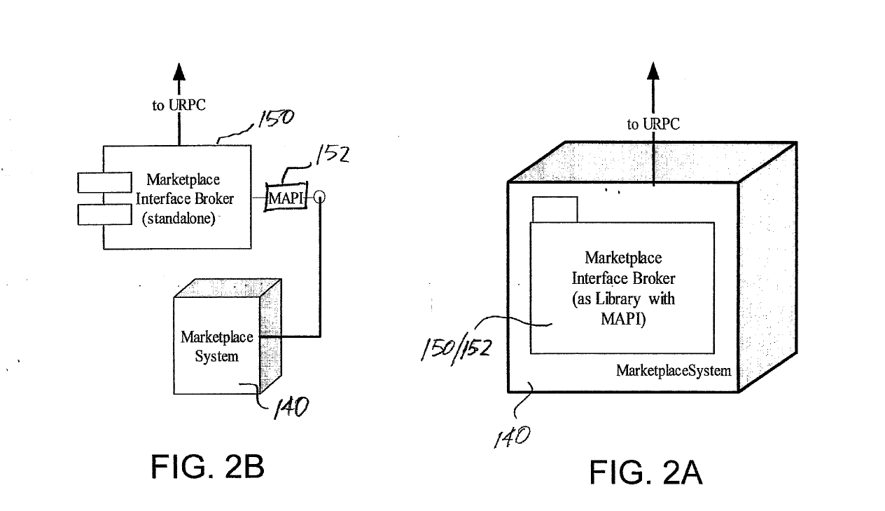

Each marketplace system 140 includes or uses a marketplace interface broker module 150 to exchange data between the URPC 110 and the marketplace and to react to events from the URPC 110. The marketplace interface broker module 150 is a component of the CNBURS 100 and its responsibility is to provide a MAPI 152 for all marketplace systems 140. As illustrated in FIG. 2A, the MAPI 152 may be implemented in the form of a software component included in the marketplace system 140. As shown in FIG. 2B, the MAPI 152 may also be implemented as a standalone computer program that can relay on a remote procedure call (RPC) protocol (e.g., Web Services, XML-RPC). Any of the MIB/MAPI/marketplace system combinations depicted in the CNBURS 100 of FIG. 1 may take the form shown in either FIGS. 2A or 2B or other combinations providing equivalent functionality.

Each service offering system 130 is connected to the URPC 110 through a computer network 120. One or more of the service offering systems 130 may be connected to the URPC 110 via the same computer network(s) 120 connecting one or more of the marketplace systems 140 to the URPC 110. One or more of the service offering systems 130 may also be connected to the URPC 110 via different computer network(s) 120 than the computer network(s) 120 connecting one or more of the marketplace systems 140 to the URPC 110.

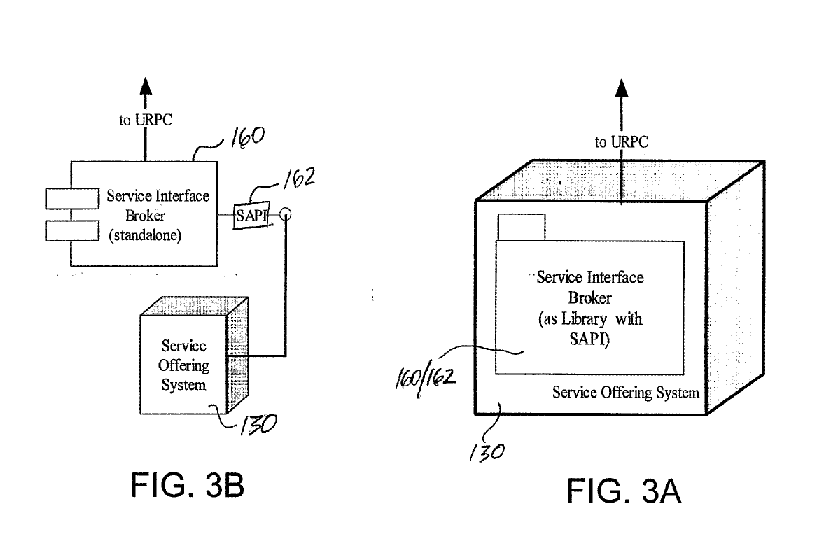

The service offering system 130 includes or uses a service interface broker module 160 of the CNBURS 100. The service interface broker module 160 provides a SAPI 162 for all service offering systems 130. The SAPI 162 provides the ability to create, send and control service offers 132 in URPC 110. As illustrated in FIG. 3A, the SAPI 162 may be implemented in the form of a software component included in the service offering system 130. As shown in FIG. 3B, the SAPI 162 may also be implemented as a standalone computer program that can relay on a remote procedure call (RPC) protocol (e.g., Web Services, XML-RPC). Any of the SIB/SAPI/SOS combinations depicted in the CNBURS 100 of FIG. 1 may take the form shown in either FIGS. 3A or 3B or other combinations providing equivalent functionality.

Exemplary specifications for the aforementioned APIs (SAPI 162 and MAPI 152) are summarized in Table 1 (SAPI Specification) and Table 2 (MAPI specification).

TABLE 1
1 SAPI specification
1.1 Endpoint
The Endpoint is the main entity that represents the Service Offering Systems in
CNBURS. Possible operations for this interface are listed below:

| Name: | Return value: | |
|---|---|---|
| company | handle to ICompany interface | |
| Name: | Return value: | |
| services | handle to IServices interface | |
| Name: | Return value: | |
| clients | handle to IClients interface | |
| Name: | Return value: | |
| resources | handle to IResources interface | |
| Name: | Return value: | |
| reservations | handle to IReservations interface | |
| Name: | Return value: | |
| net | handle to INet interface | |
| Name: | Return value: | |
| sync | handle to ISync interface | |
| Name: | Return value/description | Return type |
| init | Initializes endpoint interfaces | |
| Parameter name: | Parameter description: | Parameter type |
| vendor | Service Provider identification | string |
| appname | Service Provide System identification | string |
| Name: | Return value/description | Return type |
| start | Boots endpoint and perform login | |
| | into CNBURS if necessary. Need to | |
| | be called after init, but before any | |
| | other Endpoint operations. | |
| Name: | Return value/description | Return type |
| shutdown | Log off from CNBURS and shut | |
| | down endpoint | |
| Name: | Return value/description | Return type |
| setConfig | Set new endpoint configuration | |
| Parameter name: | Parameter description: | Parameter type |
| pConf | new configuration data | handle to RPConfiguration |
| Name: | Return value/description | Return type |
| getAppIdent | Return Service Offering System | string |
| | identification | |
| Name: | Return value/description | Return type |
| getVersion | Get Service Interface Broker version | string |
| Name: | Return value/description | Return type |
| isRunning | Returns true if Endpoint is started, | bool |
| | false otherwise | |

1.2 ICompany
This is the Interface for managing Service Provider company that the endpoint represents

| | | |
|---|---|---|
| Name: | Return value/description | Return type |
| update | update Company data in endpoint | |
| Parameter name: | Parameter description: | Parameter type |
| pCompany | Company data | handle |
| Name: | Return value/description | Return type |
| get | Get company data from endpoint | handle |

1.3 IClients
The IClients interface is an interface for managing media users, that are allowed to create
reservations for Endpoint's services. Possible operations for this interface are listed
below:

| | | |
|---|---|---|
| Name: | Return value/description | Return type |
| create | add new Client instance to endpoint | |
| Parameter name: | Parameter description: | Parameter type |
| pClient | new Client to be added | handle |
| Name: | Return value/description | Return type |
| update | update existing Client instance in | |
| | endpoint | |
| Parameter name: | Parameter description: | Parameter type |
| pClient | Client to be updated | handle |
| Name: | Return value/description | Return type |
| erase | erase existing Client instance from | |
| | endpoint | |
| Parameter name: | Parameter description: | Parameter type |
| pClient | Client to be erased | handle |
| Name: | Return value/description | Return type |
| findByProfile | Find and return Client object for | handle |
| | given profile identifier | |
| Parameter name: | Parameter description: | Parameter type |
| pClient | profile identifier | string |

1.4 IServices
The IService is an interface for managing services advertised by Endpoint in Media.
Possible operations for this interface are listed below:

| | | |
|---|---|---|
| Name: | Return value/description | Return type |
| create | add new Service instance to endpoint | |
| Parameter name: | Parameter description: | Parameter type |
| pService | new Service to be added | handle |
| Name: | Return value/description | Return type |
| update | update existing Service instance in | |
| | endpoint | |
| Parameter name: | Parameter description: | Parameter type |
| pService | Service to be updated | handle |
| Name: | Return value/description | Return type |
| erase | erase existing Service instance from | |
| | endpoint | |
| Parameter name: | Parameter description: | Parameter type |
| pService | Service to be erased | handle |

1.5 IResources
The IResources is an interface for managing resources that are capable to perform
services to clients. Possible operations for this interface are listed below:

| | | |
|---|---|---|
| Name: | Return value/description | Return type |
| create | add new Resource instance to | |
| | endpoint | |
| Parameter name: | Parameter description: | Parameter type |
| pResource | new Resource to be added | handle |
| Name: | Return value/description | Return type |
| update | update existing Resource instance in | |
| | endpoint | |
| Parameter name: | Parameter description: | Parameter type |
| pResource | Resource to be updated | handle |
| Name: | Return value/description | Return type |
| erase | erase existing Resource instance from | |
| | endpoint | |
| Parameter name: | Parameter description: | Parameter type |
| pResource | Resource to be erased | handle |
| Name: | Return value/description | Return type |
| findParent | Find resource that is parent to given | handle |
| | resource in resource hierarchy | |
| Parameter name: | Parameter description: | Parameter type |
| pResource | child resource | handle |
| Name: | Return value/description | Return type |
| findSkilledResources | Get list of resources that are capable | list of handles |
| | of serving given service. | |
| Parameter name: | Parameter description: | Parameter type |
| pService | service that needs to be served | handle |
| Name: | Return value/description | Return type |
| getChildren | Get list of child resources. | list of handles |
| Parameter name: | Parameter description: | Parameter type |
| pResource | parent resource | handle |
| Name: | Return value/description | Return type |
| getRoot | Get root resource of resource | handle |
| | hierarchy | |

1.6 IReservations
This is the Interface for managing reservations created in endpoint. Possible operations
for this interface are listed below:

| | | |
|---|---|---|
| Name: | Return value/description | Return type |
| create | add new Reservation instance to | |
| | endpoint | |
| Parameter name: | Parameter description: | Parameter type |
| pReservation | new Reservation to be added | handle |
| Name: | Return value/description | Return type |
| update | update existing Reservation instance | |
| | in endpoint | |
| Parameter name: | Parameter description: | Parameter type |
| pReservation | Reservation to be updated | handle |
| Name: | Return value/description | Return type |
| erase | erase existing Reservation instance | |
| | from endpoint | |
| Parameter name: | Parameter description: | Parameter type |
| pReservation | Reservation to be erased | handle |
| Name: | Return value/description | Return type |
| find | Find reservation with given | handle |
| | reservation ID and return handle to it | |
| Parameter name: | Parameter description: | Parameter type |
| pReservationID | reservation number | string |
| Name: | Return value/description | Return type |
| getList | Get list of reservations with items | list of handles |
| | created for given resource | |
| Parameter name: | Parameter description: | Parameter type |
| pResource | resource | handle |
| Name: | Return value/description | Return type |
| getList | Get list of reservations with items | list of handles |
| | created in given period of time | |
| Parameter name: | Parameter description: | Parameter type |
| pPeriod | period of time | handle |
| Name: | Return value/description | Return type |
| getListByProfile | Get list of reservations created by | list of handles |
| | given Profile | |
| Parameter name: | Parameter description: | Parameter type |
| pProfileIdent | Profile identifier | string |

1.7 INet
This is the Interface for managing registration in CNBURS Scheduling Agent. Possible
operations for this interface are listed below:

| | | |
|---|---|---|
| Name: | Return value/description | Return type |
| login | perform login procedure for endpoint | |
| | in CNBURS | |
| Name: | Return value/description | Return type |
| logout | perform logout procedure for | |
| | endpoint in CNBURS | |
| Name: | Return value/description | Return type |
| isLoggedIn | Check if endpoint is logged into | bool |
| | CNBURS. Returns true if endpoint is | |
| | logged in, false otherwise | |
| Name: | Return value/description | Return type |
| setAutoLogin | Set endpoint to perform login | |
| | procedure every time Endpoint::start | |
| | is called. If set, then endpoint will be | |
| | trying to login automatically | |
| | everytime when connection between | |
| | CNBURS and endpoint is broken. | |
| Parameter name: | Parameter description: | Parameter type |
| pTimeout | number of seconds between login | integer |
| | tries | |

1.8 ISync
This is the Interface for getting information about synchronization of endpoint data
between Service Interface Broker and CNBURS. Possible operations for this interface are
listed below:

| | | |
|---|---|---|
| Name: | Return value/description | Return type |
| isSyncing | Check if endpoint is sending | bool |
| | modifications in logical model to | |
| | CNBURS. Returns true if | |
| | synchronization is active, false | |
| | otherwise | |

1.9 RPConfiguration
This is the Configuration of endpoint that is passed to CNBURS. This configuration
changes the way that CNBURS behaves when interacting with Media Interfaces. Possible
operations for this interface are listed below:

| | | |
|---|---|---|
| Name: | Return value/description | Return type |
| disableReservations | Disallow reservation creation from | |
| | all media interfaces | |
| Name: | Return value/description | Return type |
| enableReservations | Allow reservation creation from all | |
| | media interfaces | |
| Name: | Return value/description | Return type |
| getAnonFlag | Get information how anonymous | constant one of: |
| | Media Users can create reservations | ANON_DENIED: |
| | in this endpoint. | anonymous clients can create |
| | | reservations |
| | | ANON_ALLOWED: |
| | | anonymous clients cannot |
| | | create reservations |
| Name: | Return value/description | Return type |
| getWorkMode | Get information how reservation | constant one of: |
| | processing is delegated to CNBURS | ONLINE: clients can create |
| | | reservations only when |
| | | endpoint is connected to |
| | | CNBURS |
| | | OFFLINE_AS: |
| | | when endpoint is offline then |
| | | CBNSURS handles |
| | | reservations for clients. |
| Name: | Return value/description | Return type |
| reservationsEnabled | Check if endpoint enabled | bool |
| | reservation processing from media | |
| | clients | |
| Name: | Return value/description | Return type |
| reservationsAllowed | Check if CNBURS allows endpoint | bool |
| | to enable reservation processing | |
| | from media clients. This flag | |
| | overrides reservationsEnabled( ) | |
| | result. | |
| Name: | Return value/description | Return type |
| setAnonFlag | Configure endpoint behaviour | |
| | regarding reservation processing | |
| | from anonymous media clients | |
| Parameter name: | Parameter description: | Parameter type |
| pFlag | configuration constant. See | integer |
| | getAnonFlag for details. | |
| Name: | Return value/description | Return type |
| setDefaultLanguageId | Set identifier of language that is | |
| | native for endpoint. | |
| Parameter name: | Parameter description: | Parameter type |
| pLangId | String in xx_YY format, where xx | string |
| | is ISO 639 code of language and | |
| | YY is ISO 3166 code of the | |
| | country | |
| Name: | Return value/description | Return type |
| setWorkMode | Configure CNBURS delegation of | |
| | reservation processing when endpoint | |
| | loses connection to CNBURS | |
| Parameter name: | Parameter description: | Parameter type |
| pMode | configuration constant. See | integer |
| | getWorkMode for details. | |

1.10 Skill
This describes relation between Resource and Service (ability to perform Services by
Resrouce)

| | | |
|---|---|---|
| Name: | Return value/description | Return type |
| getPeriodListId | Get identifier of resource period list | identifier |
| | that resource uses for exposing free | |
| | reservation slots for service related | |
| | to this skill | |
| Name: | Return value/description | Return type |
| getServiceIdent | Get identifier of Service from | identifier |
| | IServices list that this skill describes | |
| Name: | Return value/description | Return type |
| setPeriodListId | Set identifier of existing resource | |
| | period list that will be used by media | |
| | to compute free time slots for | |
| | reservations for service performed by | |
| | resource that this skill describes | |
| Parameter name: | Parameter description: | Parameter type |
| pListId | configuration constant. See | integer |
| | getWorkMode for details. | |

1.11 Service
This describes the service that is advertised by endpoint to clients by CNBURS

| | | |
|---|---|---|
| Name: | Return value/description | Return type |
| getMinDuration | get minimum amount of time that can | timespan |
| | be reserved to perform this service | |
| Name: | Return value/description | Return type |
| getMaxDuration | get maximum amount of time that | timespan |
| | can be reserved to perform this | |
| | service | |
| Name: | Return value/description | Return type |
| getMinPrice | get minimum price of performing this | money |
| | service | |
| Name: | Return value/description | Return type |
| getMaxPrice | get maximum price for performing | money |
| | this service | |
| Name: | Return value/description | Return type |
| getPriceSpan | Get amount of time for service price | money |
| | (service can cost per hour, per day or | |
| | if pricespan is not set then per full | |
| | reservation period) | |
| Name: | Return value/description | Return type |
| getStartDate | Get date when this service must be | timestamp |
| | performed. If service can be | |
| | performed anytime invalid date is | |
| | returned | |
| Name: | Return value/description | Return type |
| setMinDuration | Set minimum duration. See | |
| | getMinDuration for more info. | |
| Parameter name: | Parameter description: | Parameter type |
| pDuration | new minimum duration | timespan |
| Name: | Return value/description | Return type |
| setMaxDuration | Set maximum duration. See | |
| | getMaxDuration for more info. | |
| Parameter name: | Parameter description: | Parameter type |
| pDuration | new maximum duration | timespan |
| Name: | Return value/description | Return type |
| setMaxDuration | Set maximum duration. See | |
| | getMaxDuration for more info. | |
| Parameter name: | Parameter description: | Parameter type |
| pDuration | new maximum duration | timespan |
| Name: | Return value/description | Return type |
| setMinPrice | Set minimum price. See getMinPrice | |
| | for more info. | |
| Parameter name: | Parameter description: | Parameter type |
| pPrice | new minimum price | money |
| Name: | Return value/description | Return type |
| setMaxPrice | Set maximum price. See getMaxPrice | |
| | for more info. | |
| Parameter name: | Parameter description: | Parameter type |
| pDuration | new maximum price | money |
| Name: | Return value/description | Return type |
| setStartDate | Set start date. See get | |
| | StartDate for more info. | |
| Parameter name: | Parameter description: | Parameter type |
| pDate | new start date | datetime |

1.12 Reservation
This describes the reservation created in endpoint (locally or from reservation request
received from media)

| | | |
|---|---|---|
| Name: | Return value/description | Return type |
| addItem | Add ReservationItem to object | |
| Parameter name: | Parameter description: | Parameter type |
| pItem | item to be added | handle |
| Name: | Return value/description | Return type |
| updateItem | Update ReservationItem in object | |
| Parameter name: | Parameter description: | Parameter type |
| pItem | item to be updated | handle |
| Name: | Return value/description | Return type |
| eraseItem | Erase ReservationItem from object | |
| Parameter name: | Parameter description: | Parameter type |
| pItem | item to be erased | handle |
| Name: | Return value/description | Return type |
| findItem | Find ReservationItem in object item | handle |
| | list and return it | |
| Parameter name: | Parameter description: | Parameter type |
| pWork | Work data for which item should be | handle |
| | returned | |
| Name: | Return value/description | Return type |
| getItems | Get list of reservation items holded | list of handles |
| | by object | |
| Name: | Return value/description | Return type |
| getProfileIdent | Get identifier of media profile that | string |
| | sent request from media that caused | |
| | this reservation creation | |
| Name: | Return value/description | Return type |
| getProfileMobile | Get mobile phone number of media | string |
| | profile that sent request from media | |
| | that caused this reservation creation | |
| Name: | Return value/description | Return type |
| getProfileName | Get person name of media profile | string |
| | that sent request from media that | |
| | caused this reservation creation | |
| Name: | Return value/description | Return type |
| getProfileSurname | Get person surname of media profile | string |
| | that sent request from media that | |
| | caused this reservation creation | |
| Name: | Return value/description | Return type |
| getReservationId | Get unique reservation number | string |
| | assigned by CNBURS | |
| Name: | Return value/description | Return type |
| addVar | Add user defined variable to object | |
| Parameter name: | Parameter description: | Parameter type |
| pVar | variable to be added | handle |
| Name: | Return value/description | Return type |
| delVar | Remove user defined variable from | |
| | object | |
| Parameter name: | Parameter description: | Parameter type |
| pVarName | name of variable to be deleted | handle |
| Name: | Return value/description | Return type |
| getVars | Get list of user defined variables | list of handles |
| | holded by object | |
| Name: | Return value/description | Return type |
| isFromMedia | Check if reservation was created in | bool |
| | result of reservation request sent | |
| | from Media Interface Broker | |
| Name: | Return value/description | Return type |
| isOpen | Check if reservation has at least one | bool |
| | item with Work in PLANNED state | |
| Name: | Return value/description | Return type |
| close | Close reservation by setting all | |
| | Works in items to DONE state | |

1.13 ReservationItem
This is part of the Reservation that describes one time slot reservation for resource and
given service.

| | | |
|---|---|---|
| Name: | Return value/description | Return type |
| getService | Get Service for which this item is | handle |
| | created | |
| Name: | Return value/description | Return type |
| getWork | Get Work that this item encapsulates | handle |
| Name: | Return value/description | Return type |
| setService | Set Service relation of this item | |
| Parameter name: | Parameter description: | Parameter type |
| pService | Service which should be served an | handle |
| | work period to client | |
| Name: | Return value/description | Return type |
| setWork | Set Work data for this item | |
| Parameter name: | Parameter description: | Parameter type |
| pWork | Work data | handle |

1.14 Var
This is a User defined custom variable that can be bound to reservation.

| | | |
|---|---|---|
| Name: | Return value/description | Return type |
| setName | Set variable name | |
| Parameter name: | Parameter description: | Parameter type |
| pName | new name | string |
| Name: | Return value/description | Return type |
| setValue | Set variable value | |
| Parameter name: | Parameter description: | Parameter type |
| pValue | new value | string |
| Name: | Return value/description | Return type |
| getName | Get variable name | string |
| Name: | Return value/description | Return type |
| getValue | Get variable value | string |

1.15 Resource
This describes one resource capable to perform one or more services in configurable time
slots. The Resource is advertised by endpoint in CNBURS.

| | | |
|---|---|---|
| Name: | Return value/description | Return type |
| addList | create new empty period list | |
| Parameter name: | Parameter description: | Parameter type |
| pListId | list identifier | identifier |
| Name: | Return value/description | Return type |
| addPeriod | add new period to existing period list | |
| Parameter name: | Parameter description: | Parameter type |
| pPeriod | New period to add | handle |
| pListId | list identifier | identifier |
| Name: | Return value/description | Return type |
| clearperiods | clear periods on existing period list in | |
| | given time range | |
| Parameter name: | Parameter description: | Parameter type |
| pFrom | start of range | datetime |
| pTo | end of range | datetime |
| pListId | list identifier | identifier |
| Name: | Return value/description | Return type |
| findTimes | find all periods when resource is free | |
| | and cut them to pieces of pDuration | |
| | long and return as a list. First period | |
| | could be sticked to some point in | |
| | time if pGlue is not zero. | |
| Parameter name: | Parameter description: | Parameter type |
| pDuration | period duration | timespan |
| pStart | start of search range | datetime |
| pEnd | end of search range | datetime |
| pGlue | multiply of hour part from where first | timespan |
| | period should have its start point set | |
| pListId | period list identifier | identifier |
| pMatches | maximum number of returned | integer |
| | matches (−1 for unlimited) | |
| Name: | Return value/description | Return type |
| getPeriodLists | Get list of identifiers of created | list of identifiers |
| | period lists. | |
| Name: | Return value/description | Return type |
| getPeriods | Get list of periods from one of | list of handles |
| | created period lists in given time | |
| | range | |
| pStart | start of time range | datetime |
| pEnd | end of time range | datetime |
| pListId | period list identifier | identifier |
| Name: | Return value/description | Return type |
| getPeriods | Get list of periods from one of | list of handles |
| | created period lists | |
| pListId | period list identifier | identifier |
| Name: | Return value/description | Return type |
| hasList | Check if resource has period list | bool |
| | created | |
| pListId | period list identifier | identifier |
| Name: | Return value/description | Return type |
| removeList | Remove period list from resource | |
| pListId | period list identifier | identifier |
| Name: | Return value/description | Return type |
| setPeriods | Remove all existsing periods from | |
| | list and add list of new ones | |
| pPeriods | list of new periods | list of handles |
| pListId | period list identifier | identifier |
| Name: | Return value/description | Return type |
| addSkill | add new skill to resource | |
| Parameter name: | Parameter description: | Parameter type |
| pSkill | New skill to add | handle |
| Name: | Return value/description | Return type |
| eraseSkill | remove existing skill from resource | |
| Parameter name: | Parameter description: | Parameter type |
| pSkill | skill to remove | handle |
| Name: | Return value/description | Return type |
| getServices | get full list of services for which | list of handles |
| | Resource has skills | |
| Parameter name: | Parameter description: | Parameter type |
| pServices | handle to IServices interface | handle |
| Name: | Return value/description | Return type |
| getSkill | find skill for given service | handle |
| Parameter name: | Parameter description: | Parameter type |
| pService | service that resource should have | handle |
| | skill for | |
| Name: | Return value/description | Return type |
| getSkills | Get all skills for resource | list of handles |
| Name: | Return value/description | Return type |
| hasSkill | check if resource has skill for given | bool |
| | service | |
| Parameter name: | Parameter description: | Parameter type |
| pService | service to check | handle |
| Name: | Return value/description | Return type |
| setSkills | Remove existing list of skills and set | |
| | new one | |
| Parameter name: | Parameter description: | Parameter type |
| pSkills | New list of skills | list of handles |
| Name: | Return value/description | Return type |
| addWork | add new work to resource | |
| Parameter name: | Parameter description: | Parameter type |
| pWork | New work to add | handle |
| Name: | Return value/description | Return type |
| eraseWork | remove existing work from resource | |
| Parameter name: | Parameter description: | Parameter type |
| pWork | work to remove | handle |
| Name: | Return value/description | Return type |
| eraseWorks | remove existing works related to one | |
| | reservation from resource | |
| Parameter name: | Parameter description: | Parameter type |
| pReservationId | reservation identifier | string |
| Name: | Return value/description | Return type |
| findWork | Find work in resource | |
| Parameter name: | Parameter description: | Parameter type |
| pWorkId | work identifier | string |
| Name: | Return value/description | Return type |
| findWork | Find work in resource | |
| Parameter name: | Parameter description: | Parameter type |
| pReservationId | reservation identifier | string |
| pPlannedStartDate | time point when work is planned | datetime |
| Name: | Return value/description | Return type |
| getAvailability | Get availability data for resource | handle |
| Name: | Return value/description | Return type |
| getWorks | Get work list for given period of time | list of handles |
| Parameter name: | Parameter description: | Parameter type |
| pPeriod | Period of time for which works | handle |
| | should be returned | |
| Name: | Return value/description | Return type |
| hasWorkAt | Get work list for given period of time | bool |
| Parameter name: | Parameter description: | Parameter type |
| pStart | Start time point of period | datetime |
| pEnd | End time point of period | datetime |
| pExcept | If valid, then exclude this work from | handle |
| | checking | |
| Name: | Return value/description | Return type |
| isAvailable | Check if resource has working time | bool |
| | at given period | |
| Parameter name: | Parameter description: | Parameter type |
| pPeriod | Period to check | handle |
| pListId | identifier of period list that should be | identifier |
| | checked | |
| pDuration | Minimum amount of time that should | timestamp |
| | be free | |
| Name: | Return value/description | Return type |
| updateWork | Update existing work on resource list | |
| Parameter name: | Parameter description: | Parameter type |
| pWork | New work data | handle |
| Name: | Return value/description | Return type |
| setAvailability | Set media availability data for | |
| | resource | |
| Parameter name: | Parameter description: | Parameter type |
| pAvailability | availability data | handle |

1.16 Company
This describes Service Provider company that this endpoint represents.

| | | |
|---|---|---|
| Name: | Return value/description | Return type |
| getEmailAddress | Get email of company that this | string |
| | endpoint represents | |
| Name: | Return value/description | Return type |
| getIdent | Get endpoint identifier | string |
| Name: | Return value/description | Return type |
| getAddress | Get company address data | handle |
| Name: | Return value/description | Return type |
| setEmailAddress | Set email of company that this | |
| | endpoint represents | |
| Parameter name: | Parameter description: | Parameter type |
| pEmail | email data | string |
| Name: | Return value/description | Return type |
| setAddress | Set address information of company | |
| Parameter name: | Parameter description: | Parameter type |
| pAddress | address data | handle |

1.17 Address
This is part of the company that describes its localization.

| | | |
|---|---|---|
| Name: | Return value/description | Return type |
| setCountry | Set country part of address | |
| Parameter name: | Parameter description: | Parameter type |
| pName | name of country | string |
| Name: | Return value/description | Return type |
| setRegion1 | Set region1 part of address | |
| Parameter name: | Parameter description: | Parameter type |
| pName | name of region1 | string |
| Name: | Return value/description | Return type |
| setRegion2 | Set region2 part of address | |
| Parameter name: | Parameter description: | Parameter type |
| pName | name of region2 | string |
| Name: | Return value/description | Return type |
| setRegion3 | Set region3 part of address | |
| Parameter name: | Parameter description: | Parameter type |
| pName | name of region3 | string |
| Name: | Return value/description | Return type |
| setCity | Set city part of address | |
| Parameter name: | Parameter description: | Parameter type |
| pName | name of city | string |
| Name: | Return value/description | Return type |
| setQuarter | Set quarter part of address | |
| Parameter name: | Parameter description: | Parameter type |
| pName | name of quarter | string |
| Name: | Return value/description | Return type |
| setStreetAddress | Set street name and street number | |
| | part of address | |
| Parameter name: | Parameter description: | Parameter type |
| pAddress | street name and number | string |
| Name: | Return value/description | Return type |
| setPostCode | Set postal code | |
| Parameter name: | Parameter description: | Parameter type |
| pCode | postal code | string |
| Name: | Return value/description | Return type |
| setPhone | Set phone to address location | |
| Parameter name: | Parameter description: | Parameter type |
| pPhone | phone number | string |
| Name: | Return value/description | Return type |
| getCountry | Get country part of address | string |
| Name: | Return value/description | Return type |
| getRegion1 | Get region1 part of address | string |
| Name: | Return value/description | Return type |
| getRegion2 | Get region2 part of address | string |
| Name: | Return value/description | Return type |
| getRegion3 | Get region3 part of address | string |
| Name: | Return value/description | Return type |
| getCity | Get city part of address | string |
| Name: | Return value/description | Return type |
| getQuarter | Get quarter part of address | string |
| Name: | Return value/description | Return type |
| getStreetAddress | Get street name and number | string |
| Name: | Return value/description | Return type |
| getPostCode | Get post code | string |
| Name: | Return value/description | Return type |
| getPhne | Get phone related to address | string |

1.18 Period
The Period represents a time slice. It defines a start and end point in time.

| | | |
|---|---|---|
| Name: | Return value/description | Return type |
| setStart | Set start time point | |
| Parameter name: | Parameter description: | Parameter type |
| pTimestamp | date and time when period starts | datetime |
| Name: | Return value/description | Return type |
| setEnd | Set start time point | |
| Parameter name: | Parameter description: | Parameter type |
| pTimestamp | date and time when period ends | datetime |
| Name: | Return value/description | Return type |
| getStart | Get date and time when period starts | datetime |
| Name: | Return value/description | Return type |
| getEnd | Get date and time when period ends | datetime |

1.19 Client
The Client represents the description and access rights for a Media Profile. The Service
Offering System can control how the Media Profile can access the Service Schedule
using this entity.
Operations:

| | | |
|---|---|---|
| Name: | Return value/description | Return type |
| getDataAccessFlags | Returns set of permissions to | bitmask |
| | Endpoint data read/write for Profile. | |
| Name: | Return value/description | Return type |
| clearDataAccessFlags | Unsets all permissions to Endpoint | |
| | data for this Profile | |
| Name: | Return value/description | Return type |
| isDataAccessFlagSet | Returns true if given data access | bool |
| | flag is set for this Profile | |
| Parameter name: | Parameter description: | Parameter type |
| pFlag | flag value | integer |
| Name: | Return value/description | Return type |
| setDataAccessFlag | Set endpoint data access flag for | |
| | client | |
| parameter name: | Parameter description: | Parameter type |
| pFlag | flag value | integer |
| Name: | Return value/description | Return type |
| setDataAccessFlags | Set endpoint data access flags for | |
| | client | |
| Parameter name: | Parameter description: | Parameter type |
| pFlag | data access flags | bitmask |
| Name: | Return value/description | Return type |
| getProfileIdent | Returns profile identification string | string |
| Name: | Return value/description | Return type |
| getReservationPerm | Returns permission flags for Profile | integer |
| | that allows or disallows this Profile | |
| | to create or modify reservations | |
| | created by that Profile in this | |
| | endpoint. | |
| Name: | Return value/description | Return type |
| setReservationPerm | Sets permission flags for Profile that | integer |
| | allows or disallows this Profile to | |
| | create or modify reservations | |
| | created by that Profile in this | |
| | endpoint. | |
| Name: | Return value/description | Return type |
| isDenied | Check if Profile is allowed to create | bool |
| | or modify its reservations in this | |
| | endpoint. Return true if Profile is | |
| | denied, false otherwise | |

1.20 ResourceAvailability
This is part of the resource that contains rules to limit service availability from media
interfaces

| | | |
|---|---|---|
| Name: | Return value/description | Return type |
| getDurationUnits | Get number of duration units for | integer |
| | which availability calculations will | |
| | be done | |
| Name: | Return value/description | Return type |
| getAvailability | Get percent of periods that can be | integer |
| | reserved from media in given | |
| | duration | |
| Name: | Return value/description | Return type |
| getDurationType | Get type of duration unit | integer constant one of: |
| | | HOURLY, DAILY, |
| | | WEEKLY, MONTHLY, |
| | | YEARLY |
| Name: | Return value/description | Return type |
| setDuration | Set duration for availability | |
| | computation | |
| Parameter name: | Parameter description: | Parameter type |
| pDuration | duration units | integer |
| pType | duration unit type | integer constant (see |
| | | getDurationType for values) |
| Name: | Return value/description | Return type |
| setAvailability | Set percent of periods that can be | |
| | reserved from media in given | |
| | duration | |
| Parameter name: | Parameter description: | Parameter type |
| pAmount | availability value | integer (in range 0-100) |

1.21 Work
This represents time that is reserved for a resource to perform some work which causes
work time periods in aresource to be unavailable for that time.

| | | |
|---|---|---|
| Name: | Return value/description | Return type |
| getEndDate | Get time point when work was | datetime |
| | finished | |
| Name: | Return value/description | Return type |
| getPlannedDuration | Get period of planned duration for | timestamp |
| | work | |
| Name: | Return value/description | Return type |
| getPlannedEndDate | Get time point when work is | timestamp |
| | expected to be finished | |
| Name: | Return value/description | Return type |
| getPlannedStartDate | Get time point when work is | timestamp |
| | expected to be started | |
| Name: | Return value/description | Return type |
| getReservationId | Get identifier of reservation that | identifier |
| | this work belongs to | |
| Name: | Return value/description | Return type |
| getResourceId | Get identifier of resource that this | identifier |
| | work belongs to | |
| Name: | Return value/description | Return type |
| getStartDate | Get time point when work was | datetime |
| | started | |
| Name: | Return value/description | Return type |
| getWorkState | Get current state of work | integer constant one of: |
| | | PLANNED, REJECTED, |
| | | EXECUTING, |
| | | CANCELLED, |
| | | FOR_CANCEL, DONE |
| Name: | Return value/description | Return type |
| isDone | Check if work was done (is in | bool |
| | DONE state) | |
| Name: | Return value/description | Return type |
| setDone | Set work to DONE state and fille | |
| | start and end date | |
| Parameter name: | Parameter description: | Parameter type |
| pStart | time when work was started | datetime |
| pEnd | time when work was finished | datetime |
| Name: | Return value/description | Return type |
| setExecuting | Set work to EXECUTInG state and | |
| | fille start date | |
| Parameter name: | Parameter description: | Parameter type |
| pStart | time when work was started | datetime |
| Name: | Return value/description | Return type |
| setPlannedDuration | Adjust planned end date to given | |
| | duration | |
| Parameter name: | Parameter description: | Parameter type |
| pDuration | new planned duration | timespan |
| Name: | Return value/description | Return type |
| setPlannedEndDate | Set new planned end date | |
| Parameter name: | Parameter description: | Parameter type |
| pDate | new planned end date | datetime |
| Name: | Return value/description | Return type |
| setPlannedStartDate | Set new planned start date | |
| Parameter name: | Parameter description: | Parameter type |
| pDate | new planned start date | datetime |
| Name: | Return value/description | Return type |
| set WorkState | Set new work state | |
| Parameter name: | Parameter description: | Parameter type |
| pState | new state | integer constant (see |
| | | getWorkState for more info) |

1.22 RootObject
This is the base class for Service, Resource, Reservation and Company that provides
multilanguage support for advertising those objects in CNBURS.

| | | |
|---|---|---|
| Name: | Return value/description | Return type |
| setName | Set name of object in given | |
| | language | |
| Parameter name: | Parameter description: | Parameter type |
| pName | New object name | string |
| pLanguage | Language identifier for language in | string |
| | which name is specified | |
| Name: | Return value/description | Return type |
| setDescription | Set description of object in given | |
| | language | |
| Parameter name: | Parameter description: | Parameter type |
| pDescription | New object description | string |
| pLanguage | Language identifier for language in | string |
| | which description is specified | |
| Name: | Return value/description | Return type |
| getName | Get name of object in given | |
| | language | |
| Parameter name: | Parameter description: | Parameter type |
| pLanguage | Language identifier | string |
| Name: | Return value/description | Return type |
| getDescription | Get description of object in given | |
| | language | |
| Parameter name: | Parameter description: | Parameter type |
| pLanguage | Language identifier | string |
| Name: | Return value/description | Return type |
| getNameLanguages | Get list of language identifiers for | list of identifiers |
| | which names are set | |
| Name: | Return value/description | Return type |
| getDescLanguages | Get list of language identifiers for | list of identifiers |
| | which descriptions are set | |
| Name: | Return value/description | Return type |
| clearName | Clear name in given language | |
| Parameter name: | Parameter description: | Parameter type |
| pLanguage | Language identifier | string |
| Name: | Return value/description | Return type |
| clearDescription | Clear description in given language | |
| Parameter name: | Parameter description: | Parameter type |
| pLanguage | Language identifier | string |

TABLE 2
2 MAPI specification
The MAPI specification includes model classes, requests that can be processed by
CNBURS, and descriptions of replies to the requests.
2.1 Common operations for all requests and replies
The two points below list operations that are shared by all requests and replies in the
MAPI interface.
2.1.1 Requests

| | | |
|---|---|---|
| Name: | Return value/description | Return type |
| setRequestId | Set new request identifier. Request | |
| | identifier must be unique in session | |
| | context | |
| Parameter name: | Parameter description: | Parameter type |
| pId | request identifier | identifier |
| Name: | Return value/description | Return type |
| setSessionId | Set new session identifier. If | |
| | empty, then CNBURS will create | |
| | new session and return its identifier | |
| | in reply to this request | |
| Parameter name: | Parameter description: | Parameter type |
| pId | session identifier | identifier |

The following operations are shared by requests that need an authorized session. Those
requests are:
ProfileChangeRequest
ReservationListRequest
ReservationRequest

| | | |
|---|---|---|
| Name: | Return value/description | Return type |
| setAuthData | Set profile authorization for | |
| | session. When request with | |
| | authorization is received, then | |
| | session created in CNBURS | |
| | becomes authorized. | |
| Parameter name: | Parameter description: | Parameter type |
| pProfileIdent | profile identifier | identifier |
| pProfilePassword | profile password data | string |

2.1.2 Replies
The following operations are shared by all replies.

| | | |
|---|---|---|
| Name: | Return value/description | Return type |
| getRequestId | Get request identifier that this reply | identifier |
| | is for | |
| Name: | Return value/description | Return type |
| getSessionId | Get session identifier of session | identifier |
| | context where request is processed | |
| Name: | Return value/description | Return type |
| getStatus | Get request status | constant one of: |
| | | RP_REQUEST_AUTH_NEE |
| | | DED: Request is waiting for |
| | | authorization code |
| | | RP_REQUEST_PROCESSING: |
| | | CNBURS is processing |
| | | request |
| | | RP_REQUEST_AWAITING: |
| | | Request is done on server side |
| | | but needs to be sent to irs |
| | | endpoint |
| | | RP_REQUEST_DONE: |
| | | Request is done. |
| | | RP_REQUEST_FAILED: |
| | | CNBURS failed to complete |
| | | request |
| | | RP_REQUEST_NO_AUTH_CODE: |
| | | Request expired |
| | | without auth code received |

2.2 City
City is a part of the Location object.

| | | |
|---|---|---|
| Name: | Return value/description | Return type |
| getName | Get name of City | string |
| Name: | Return value/description | Return type |
| getDictId | Get localization identifier for | integer |
| | object | |

2.3 Company
Company describes the Service Provider name, contact and localization data. It also
contains access methods to the Service Provider resources and available services

| | | |
|---|---|---|
| Name: | Return value/description | Return type |
| findResource | Find resource using its identifier | handle to Resource object |
| Parameter name: | Parameter description: | Parameter type |
| pIdent | Resource identifier | string |
| Name: | Return value/description | Return type |
| findService | Find service using its identifier | handle to Service object |
| Parameter name: | Parameter description: | Parameter type |
| pIdent | Resource identifier | string |
| Name: | Return value/description | Return type |
| getDescription | Get text that describes Service | string |
| | Provider | |
| Parameter name: | Parameter description: | Parameter type |
| pDefault | If true, then description in endpoint | string |
| | default language is returned, | |
| | otherwise description in session | |
| | language is returned | |
| Name: | Return value/description | Return type |
| getEmailAddress | Get email address of Service | string |
| | Provider | |
| Name: | Return value/description | Return type |
| getIdent | Get URS identifier assigned to | string |
| | endpoint when it was registered | |
| | into system | |
| Name: | Return value/description | Return type |
| getLocation | Get location description | handle to Location object |
| Name: | Return value/description | Return type |
| getName | Get name of Service Provider | string |
| Parameter name: | Parameter description: | Parameter type |
| pDefault | If true, then name in endpoint | string |
| | default language is returned, | |
| | otherwise name in session language | |
| | is returned | |
| Name: | Return value/description | Return type |
| getPhone | Get Service Provider contact phone | string |
| | number | |
| Name: | Return value/description | Return type |
| getRootResource | Get root of resource tree | handle to Resource object |
| Name: | Return value/description | Return type |
| getServices | Get list of available services | list of handles to Service |
| | | objects |
| Name: | Return value/description | Return type |
| getStreetAddress | Get street address | string |

2.4 CompanyMatch
The Company match is a part of CompanyReply that contains single endpoint data and
flags for data access to the session that issued CompanyRequest.

| | | |
|---|---|---|
| Name: | Return value/description | Return type |
| getCompany | Get company data | handle to Company object |
| Name: | Return value/description | Return type |
| getDataAccessFlags | Get list of flags that defines data | constant one of |
| | access for current session. If | ENDPOINT_DATA_RESERVATIONS_READ |
| | session has “read” flag set then it | or |
| | can read all reservation data from | _DATA_RESERVATIONS_WRITE |
| | endpoint. If session has “write” | |
| | flag set then it can modify endpoint | |
| | reservations. | |
| Name: | Return value/description | Return type |
| getResStatus | Get permission flag for making | constant one of Possibile |
| | reservation. | return values: |
| | | IRS_MRES_EXTERNAL_AUTH |
| | | external auth needed |
| | | IRS_MRES_ALLOWED |
| | | reservation creation allowed |
| | | for this session. |
| | | IRS_MRES_ALLOWED_FOR_ACCEPT |
| | | reservation |
| | | creation allowed for this |
| | | session but works will be |
| | | always created with status |
| | | IRS_WO_STATE_FOR_ACCEPT. |
| | | All services have |
| | | “FOR_ACCEPT” flag forced |
| | | in match regardless of |
| | | configuration in Irs endpoint. |
| | | IRS_MRES_ANON_DENIED |
| | | reservation creation from |
| | | unauthorized session is |
| | | denied. |
| | | IRS_MRES_CLIENT_DENIED |
| | | reservation creation is |
| | | denied for this session. |
| | | * |
| | | IRS_MRES_RESERVATIIONS_DISABLED |
| | | endpoint |
| | | cannot accept reservation |
| | | requests |
| Name: | Return value/description | Return type |
| getScore | Get points that this match got for | integer |
| | search criteria. | |
| Name: | Return value/description | Return type |
| isActive | Check if endpoint is active | boolean |
| | (reservations can be made) | |
| Name: | Return value/description | Return type |
| isServiceMatched | Returns true if given service | boolean |
| | matched search criteria, for which | |
| | this match was generated | |
| Parameter name: | Parameter description: | Parameter type |
| pService | service object to check | handle to Service object |

2.5 Location
The Location describes endpoint location against the location tree.

| | | |
|---|---|---|
| Name: | Return value/description | Return type |
| getCity | Get city part of location | handle to City object |
| Name: | Return value/description | Return type |
| getCountry | Get country part of location | handle to Country object |
| Name: | Return value/description | Return type |
| getQuarter | Get quarter part of location | handle to Quarter object |
| Name: | Return value/description | Return type |
| getRegion1 | Get region at level 1 part of | handle to GenericRegion |
| | location | object |
| Name: | Return value/description | Return type |
| getRegion2 | Get region at level 2 part of | handle to GenericRegion |
| | location | object |
| Name: | Return value/description | Return type |
| getRegion3 | Get region at level 3 part of | handle to GenericRegion |
| | location | object |
| Name: | Return value/description | Return type |
| setCity | Set city part of location | |
| Parameter name: | Parameter description: | Parameter type |
| pCity | City data to set | handle to City object |
| Name: | Return value/description | Return type |
| setCountry | Set country part of location | |
| Parameter name: | Parameter description: | Parameter type |
| pCountry | Country data to set | handle to Country object |
| Name: | Return value/description | Return type |
| setQuarter | Set quarter part of location | |
| Parameter name: | Parameter description: | Parameter type |
| pQuarter | Quarter data to set | handle to Quarter object |
| Name: | Return value/description | Return type |
| setRegion1 | Set region data at level 1 | |
| Parameter name: | Parameter description: | Parameter type |
| pRegion1 | Region data to set | handle to GenericRegion |
| | | object |
| Name: | Return value/description | Return type |
| setRegion2 | Set region data at level 2 | |
| Parameter name: | Parameter description: | Parameter type |
| pRegion2 | Region data to set | handle to GenericRegion |
| | | object |
| Name: | Return value/description | Return type |
| setRegion3 | Set region data at level 3 | |
| Parameter name: | Parameter description: | Parameter type |
| pRegion3 | Region data to set | handle to GenericRegion |
| | | object |

2.6 Period
The Period represents a time slice. It defines a start and end point in time.

| | | |
|---|---|---|
| Name: | Return value/description | Return type |
| setStart | Set start time point | |
| Parameter name: | Parameter description: | Parameter type |
| pTimestamp | date and time when period starts | datetime |
| Name: | Return value/description | Return type |
| setEnd | Set start time point | |
| Parameter name: | Parameter description: | Parameter type |
| pTimestamp | date and time when period ends | datetime |
| Name: | Return value/description | Return type |
| getStart | Get date and time when period starts | datetime |
| Name: | Return value/description | Return type |
| getEnd | Get date and time when period ends | datetime |

2.7 Profile
The Profile describes a media user that is able to search and make reservations to the
Service Provider endpoints using the media interface.

| | | |
|---|---|---|
| Name: | Return value/description | Return type |
| getCreationDate | Get date and time when profile was | datetime |
| | created | |
| Name: | Return value/description | Return type |
| getEmailAddress | Get email address of profile owner | string |
| Name: | Return value/description | Return type |
| getIdent | Get profile identifier | string |
| getLastModified | Get date and time when profile was | datetime |
| Date | last time modified | |
| Name: | Return value/description | Return type |
| getName | Get name of profile owner | string |
| Name: | Return value/description | Return type |
| getPassword | Get password data of profile owner | string |
| Name: | Return value/description | Return type |
| getPhone | Get contact phoneof profile owner | string |
| Name: | Return value/description | Return type |
| getSurname | Get surname of profile owner | string |
| Name: | Return value/description | Return type |
| isTemporary | Return true if profile ident is locked | Boolean |
| | but profile is not fully operational | |
| Name: | Return value/description | Return type |
| setEmailAddress | Set profile owner email address | |
| Parameter name: | Parameter description: | Parameter type |
| pAddress | email address | string |
| Name: | Return value/description | Return type |
| setIdent | Set profile identification | |
| Parameter name: | Parameter description: | Parameter type |
| pIdent | unique profile identifier | string |
| Name: | Return value/description | Return type |
| setName | Set profile owner name | |
| Parameter name: | Parameter description: | Parameter type |
| pName | name of profile owner | string |
| Name: | Return value/description | Return type |
| setPassword | Set profile owner password | |
| Parameter name: | Parameter description: | Parameter type |
| pPassword | password data | string |
| Name: | Return value/description | Return type |
| setPhone | Set profile owner phone | |
| Parameter name: | Parameter description: | Parameter type |
| pPhone | phone of profile owner | string |
| Name: | Return value/description | Return type |
| setSurname | Set profile owner surname | |
| Parameter name: | Parameter description: | Parameter type |
| pSurname | surname of profile owner | string |
| Name: | Return value/description | Return type |
| setTemporary | Make profile temporary or fully | |
| | operational | |
| Parameter name: | Parameter description: | Parameter type |
| pFlag | true if profile should be temporary, | bool |
| | false if fully operational | |

2.8 Country
The Country is a part of the Location object.

| | | |
|---|---|---|
| Name: | Return value/description | Return type |
| getName | Get name of City | string |
| Name: | Return value/description | Return type |
| getDictId | Get localization identifier for | integer |
| | object | |

2.9 GenericRegion
The GenericRegion is a part of the Location object.

| | | |
|---|---|---|
| Name: | Return value/description | Return type |
| getName | Get name of City | string |
| Name: | Return value/description | Return type |
| getDictId | Get localization identifier for | integer |
| | object | |

2.10 Quarter
The Quarter is a part of the Location object.

| | | |
|---|---|---|
| Name: | Return value/description | Return type |
| getName | Get name of City | string |
| Name: | Return value/description | Return type |
| getDictId | Get localization identifier for | integer |
| | object | |

2.11 Reservation
This describes the reservation created in URS. The Reservation contains list of
ReservationCompanyItems. Every item contains reservation data related to single
endpoint.

| | | |
|---|---|---|
| Name: | Return value/description | Return type |
| getItems | Get reservation data for every | list of |
| | endpoint | ReservationCompanyItems |
| | | objects |
| Name: | Return value/description | Return type |
| getProfileIdent | Get identifier of Profile that created | string |
| | this reservation. Can be empty if | |
| | reservation was created by | |
| | endpoint. | |
| Name: | Return value/description | Return type |
| getReservationCode | Get authorization code created by | string |
| | URS | |
| Name: | Return value/description | Return type |
| getReservationId | Get reservation identifier created | string |
| | by URS | |
| Name: | Return value/description | Return type |
| getStatus | Get current reservation status | constant one of: |
| | | RES_STATE_PROCESSING: |
| | | Reservation is being |
| | | processed |
| | | RES_STATE_AUTH_WAITING: |
| | | Reservation is waiting |
| | | for auth code |
| | | RES_STATE_AWAITING: |
| | | Reservation is done on URS |
| | | side and waiting to be sent to |
| | | endpoint |
| | | RES_STATE_SENT: |
| | | Reservation is done and sent |
| | | to endpoint |

2.12 ReservationCompanyItems
This describes the list of reservation items related to single endpoint

| | | |
|---|---|---|
| Name: | Return value/description | Return type |
| getCompany | Get Service Provider description | handle to Company object |
| Name: | Return value/description | Return type |
| getItems | Get list of reservation items | list of ReservationItem |
| | | objects |
| Name: | Return value/description | Return type |
| isActive | Check if endpoint was active at | bool |
| | time when this object was created. | |
| | If endpoint was active then | |
| | reservation items can be modified. | |

2.13 ReservationItem
This describes a single reserved time slot in one endpoint.

| | | |
|---|---|---|
| Name: | Return value/description | Return type |
| getPeriod | Get reserved date and time data | handle to Period object |
| Name: | Return value/description | Return type |
| getResourceIdent | Get identifier of resource which | string |
| | will serve reserved service at | |
| | defined period | |
| Name: | Return value/description | Return type |
| getResourceName | Get name of resource which will | string |
| | serve reserved service at defined | |
| | period | |
| Name: | Return value/description | Return type |
| getWorkIdent | Get identifier of work created for | string |
| | this item | |
| Name: | Return value/description | Return type |
| getWorkName | Get name of work created for this | string |
| | item | |
| Name: | Return value/description | Return type |
| getWorkState | Get current state of work created | string |
| | for this item | |

2.14 Resource
This describes one resource capable of performing one or more services in configurable
time slots. The Resource is advertised by the endpoint in CNBURS.

| | | |
|---|---|---|
| Name: | Return value/description | Return type |
| getSkills | Get all skills for resource | list of handles |
| Name: | Return value/description | Return type |
| hasSkill | check if resource has skill for given | bool |
| | service | |
| Parameter name: | Parameter description: | Parameter type |
| pServiceIdent | service to check | string |
| Name: | Return value/description | Return type |
| getChildren | Get list of child resources in | list of handles |
| | resource tree hierarchy | |

2.15 Service

| | | |
|---|---|---|
| Name: | Return value/description | Return type |
| getDescription | Get text that describes Service | string |
| | Provider | |
| Parameter name: | Parameter description: | Parameter type |
| pDefault | If true, then description in endpoint | string |
| | default language is returned, | |
| | otherwise description in session | |
| | language is returned | |
| Name: | Return value/description | Return type |
| getName | Get name of Service Provider | string |
| Parameter name: | Parameter description: | Parameter type |
| pDefault | If true, then name in endpoint | string |
| | default language is returned, | |
| | otherwise name in session language | |
| | is returned | |
| Name: | Return value/description | Return type |
| getMaxPrice | Get maximum price set by endpoint | money |
| | for Service | |
| Name: | Return value/description | Return type |
| getMinPrice | Get minimum price set by endpoint | money |
| | for Service | |
| Name: | Return value/description | Return type |
| needsAccept | Check if reservation of this service | bool |
| | has to be confirmed by Service | |
| | Provider | |

2.16 Skill
Skill is a relation between a Resource and a Service. If this relation exitsts, then a
Resource is able to provide the related service to the Client.

| | | |
|---|---|---|
| Name: | Return value/description | Return type |
| getServiceIdent | Get service identifier | string |

2.17 Work
Work describes reserved time slots for a Resource

| | | |
|---|---|---|
| Name: | Return value/description | Return type |
| getName | Get name of work | string |
| Name: | Return value/description | Return type |
| getPlannedStart | Get planned start date and time of | datetime |
| | work | |
| Name: | Return value/description | Return type |
| getPlannedEnd | Get planned end date and time of | datetime |
| | work | |
| Name: | Return value/description | Return type |
| getWorkState | Get current state of work | constants same as |
| | | Work::getWorkState in SAPI |

2.18 CityReply
Reply to CityRequest

| | | |
|---|---|---|
| Name: | Return value/description | Return type |
| getCities | Get list of returned cities | list of handles to City objects |

2.19 CityRequest
This is a request for list of cities from location catalog

| | | |
|---|---|---|
| Name: | Return value/description | Return type |
| setCountryId | Set id of country that city should | |
| | belong to. | |
| Parameter name: | Parameter description: | Parameter type |
| pCountryId | parent country identifier | identifier |
| Name: | Return value/description | Return type |
| setRegion1Id | Set id of region on level 1 that city | |
| | should belong to. | |
| Parameter name: | Parameter description: | Parameter type |
| pRegionId | region identifier | identifier |
| Name: | Return value/description | Return type |
| setRegion2Id | Set id of region on level 2 that city | |
| | should belong to. | |
| Parameter name: | Parameter description: | Parameter type |
| pRegionId | region identifier | identifier |
| Name: | Return value/description | Return type |
| setRegion3Id | Set id of region on level 3 that city | |
| | should belong to. | |
| Parameter name: | Parameter description: | Parameter type |
| pRegionId | region identifier | identifier |

2.20 CompanyEntries
The CompanyEntries parameter is a part of the ReservationReply related to single
endpoint.

| | | |
|---|---|---|
| Name: | Return value/description | Return type |
| getReservationEntries | Get list of reserved time slots for | list of handles to |
| | endpoint | ReservationEntry objects |
| Name: | Return value/description | Return type |
| getResult | Get result of reservation request | constant one of: |
| | operation | CR_DEMO_LIMIT_EXCEE |
| | | DED: Reservation limit in |
| | | demo mode exceeded |
| | | CR_CLIENT_DENIED: This |
| | | profile is not allowed to make |
| | | reservation in irs point |
| | | CR_ANON_REQUEST_DE |
| | | NIED: This irs point does not |
| | | allow anonymous reservation |
| | | creation |
| | | CR_NO_VALID_ENTRIES: |
| | | Internal error —reply is empty |
| | | CR_RESERVATION_ACCE |
| | | PTED: All reservations in |
| | | entries was accepted |
| | | CR_READ_ONLY_STATE: |
| | | Irs endpoint is not active, |
| | | cannot create/update |
| | | reservation |
| | | CR_TOO_MANY_RESERV |
| | | ATIONS: This profile cannot |
| | | make more reservations |
| | | CR_RESERVATION_MODI |
| | | FlED: Modification of |
| | | reservation was successful |

2.21 CompanyReply
Reply to CompanyRequest

| | | |
|---|---|---|
| Name: | Return value/description | Return type |
| getCount | Get total object count that reply | integer |
| | contains | |
| Name: | Return value/description | Return type |
| getMatches | Get list of matches | list of handles to |
| | | CompanyMatch objects |
| Name: | Return value/description | Return type |
| getPosition | Get match position from which | integer |
| | matches were returned | |

2.22 CompanyRequest
Request for list of CNBURS endpoints that matches given search criteria.

| | | |
|---|---|---|
| Name: | Return value/description | Return type |
| getCount | Get number of endpoint that | integer |
| | CNBURS should return in reply | |
| Name: | Return value/description | Return type |
| getMinPoints | Get minimum amount of points that | integer |
| | each endpoint in returned reply | |
| | should reach. | |
| Name: | Return value/description | Return type |
| setCount | Set number of endpoint that | |
| | CNBURS should return in reply | |
| Parameter name: | Parameter description: | Parameter type |
| pCount | number of endpoints | integer |
| Name: | Return value/description | Return type |
| setQuery | Set search query. | |
| Parameter name: | Parameter description: | Parameter type |
| pCount | number of endpoints | integer |
| Name: | Return value/description | Return type |
| setMinPoints | Get minimum amount of points that | |
| | each endpoint in returned reply | |
| | should reach. | |
| Parameter name: | Parameter description: | Parameter type |
| pCount | number of points | integer |

2.23 CountryReply
Reply to CountryRequest

| | | |
|---|---|---|
| Name: | Return value/description | Return type |
| getCountries | Get list of returned countries | list of handles to Country |
| | | objects |

2.24 CountryRequest
Request for list of countries that exists in location catalog. This request does not have any
operations.
2.25 URS
This class represents CNBURS main interface. It allows URS to send requests to
CNBURS and receive replies.

| | | |
|---|---|---|
| Name: | Return value/description | Return type |
| sendReqeust | send request to CNBURS and | handle to reply of type that |
| | return reply | match request sent. |
| Parameter name: | Parameter description: | Parameter type |
| pReqeust | request to send | handle to request object |

2.26 PeriodQuery
PeriodQuery is a part of ServiceRequest.

| | | |
|---|---|---|
| Name: | Return value/description | Return type |
| getDuration | Get time duration that needs to be | timespan |
| | reserved | |
| Name: | Return value/description | Return type |
| getLimit | Get maximum number of periods | integer |
| | that will be returned for this query | |
| Name: | Return value/description | Return type |
| getRange | Get date and time range of interest | handle to Period object |
| Name: | Return value/description | Return type |
| getResourceIdent | Get identifier of Resource that will | identifier |
| | be queried. | |
| Name: | Return value/description | Return type |
| setDuration | Set time duration that needs to be | |
| | reserved | |
| Parameter name: | Parameter description: | Parameter type |
| pDuration | duration to set | timespan |
| Name: | Return value/description | Return type |
| setLimit | Set maximum number of periods | |
| | that will be returned for this query | |
| Parameter name: | Parameter description: | Parameter type |
| pLimit | limit to set | integer |
| Name: | Return value/description | Return type |
| setRange | Set date and time range of interest | |
| Parameter name: | Parameter description: | Parameter type |
| pRange | date and time period | handle to Period object |
| Name: | Return value/description | Return type |
| setResourceIdent | Set identifier of Resource to query | |
| Parameter name: | Parameter description: | Parameter type |
| pIdent | resource identifier | identifier |

2.27 PeriodReply
Part of ServiceReply. One period reply corresponds to one period query in service request

| | | |
|---|---|---|
| Name: | Return value/description | Return type |
| getIndex | Get query index for this reply. | integer |
| | Index value allows to match this | |
| | object with PeriodQuery sent in | |
| | ServiceRequest | |
| Name: | Return value/description | Return type |
| getMatches | Get list of matches that this reply | list of handles to |
| | contains | ServiceReplyMatch objects |

2.28 ProfileChangeRequest
Request for change Profile data

| | | |
|---|---|---|
| Name: | Return value/description | Return type |
| setProfile | Set new profile data | |
| Parameter name: | Parameter description: | Parameter type |
| pProfile | profile data | handle to Profile object |

2.29 ProfileCreationRequest
Request for create Profile data

| | | |
|---|---|---|
| Name: | Return value/description | Return type |
| setProfile | New profile data | |
| Parameter name: | Parameter description: | Parameter type |
| pProfile | profile data | handle to Profile object |

2.30 ProfileReply
Reply to profile requests

| | | |
|---|---|---|
| Name: | Return value/description | Return type |
| getDisableCode | Get information about reason why | constant one of |
| | given profile was disabled | PRDC_NO_REASON: |
| | | Profile is ok |
| | | PRDC_SYSTEM_VIOLATION: |
| | | Profile request for non |
| | | existing ident |
| | | PRDC_NOT_ACTIVATED: |
| | | Access to profile was denied - |
| | | propably bad pass/ident pair |
| | | PRDC_PASSWORD_HACKED: |
| | | Cannot create profile - |
| | | ident already in use. |
| Name: | Return value/description | Return type |
| getProfile | Get profile data | handle Profile object or empty |
| | | handle if reply was negative |
| Name: | Return value/description | Return type |
| getResult | Get result code of request | PR_OK: Profile is ok |
| | proceesing | PR_INVALID_IDENT: |
| | | Profile request for non |
| | | existing ident |
| | | PR_AUTH_FAILED: Access |
| | | to profile was denied - |
| | | propably bad pass/ident pair |
| | | PR_IDENT_EXISTS: Cannot |
| | | create profile - ident already |
| | | in use |
| | | PR_CREATED: Profile was |
| | | created |
| | | PR_UPDATED: Profile was |
| | | updated |

2.31 ProfileRequest
ProfileReqeust is used to authorize the session between media interface and CNBURS
using Profile data.

| | | |
|---|---|---|
| Name: | Return value/description | Return type |
| setAuth | Set authorization parameters | |
| Parameter name: | Parameter description: | Parameter type |
| pIdent | profile ident | string |
| pPassword | profile password | string |

2.32 QuarterReply
Reply to QuarterRequest

| | | |
|---|---|---|
| Name: | Return value/description | Return type |
| getQuarters | Get list of returned quarters | list of handles to Quarter |
| | | objects |

2.33 QuarterRequest
Request for list of cities from location catalog

| | | |
|---|---|---|
| Name: | Return value/description | Return type |
| setCityId | Set id of city that quarter should | |
| | belong to. | |
| Parameter name: | Parameter description: | Parameter type |
| pCityId | parent city identifier | identifier |

2.34 RegionReply
Reply to RegionRequest

| | | |
|---|---|---|
| Name: | Return value/description | Return type |
| getRegions | Get list of returned regions | list of handles to |
| | | GenericRegion objects |

2.35 RegionRequest
Request for list of regions from location catalog

| | | |
|---|---|---|
| Name: | Return value/description | Return type |
| setParentId | Set id of country or region on | |
| | higher level that searched region | |
| | should belong to. | |
| Parameter name: | Parameter description: | Parameter type |
| pId | parent country or region identifier | identifier |
| Name: | Return value/description | Return type |
| setLevel | Set level of returned regions | |
| Parameter name: | Parameter description: | Parameter type |
| pLevel | level value | interger between 1 and 3 |
| | | inclusive |

2.36 QueryRequest
Request used for querying other request state or to retrieve datasets from CompanyReply.
Reply to this request is ProcessingDataReply if origin request was not fully processed yet
or reply to corresponding origin request if this reply is already prepared.

| | | |
|---|---|---|
| Name: | Return value/description | Return type |
| setQueriedRequestId | Set id of request that should be | |
| | queried | |
| Parameter name: | Parameter description: | Parameter type |
| pId | request identifier | identifier |

2.37 ReservationEntry
Part of ReservationRequest and ReservationReply that describes single reserved (or
requested) time slot in CNBURS endpoint.

| | | |
|---|---|---|
| Name: | Return value/description | Return type |
| getCompanyIdent | Get endpoint identifier for this | identifier |
| | entry | |
| Name: | Return value/description | Return type |
| getPeriod | Get reserved time range | handle to Period object |
| Name: | Return value/description | Return type |
| getResourceIdent | Get resource identifier where Work | identifier |
| | was or should be created | |
| Name: | Return value/description | Return type |
| getResourceName | Get resource name for which Work | string |
| | was created | |
| Name: | Return value/description | Return type |
| getServiceIdent | Get service identifier for which | identifier |
| | Work was or should be created | |
| Name: | Return value/description | Return type |
| getState | Get entry state | constant. |
| | | Possible values for |
| | | ReservationRequest: |
| | | RE_REQUESTED: block |
| | | given period |
| | | RE_RESERVED: make |
| | | reservation |
| | | RE_CANCELLING: cancel |
| | | reservation |
| | | for ReservationReply: |
| | | RE_NOT_FOUND: |
| | | reservation item was not |
| | | found |
| | | RE_REFUSED: endpoint |
| | | refuses to complete requested |
| | | action |
| | | RE_BLOCKED: period is |
| | | blocked |
| | | RE_RESERVED: period is |
| | | reserved |
| | | RE_CANCELLING: period is |
| | | cancelled and waiting for |
| | | confirmation from endpoint |
| | | RE_CANCELLED: period is |
| | | cancelled and cancellation is |
| | | confirmed by endpoint |
| Name: | Return value/description | Return type |
| getWorkIdent | Get work identifier of created work | identifier |
| Name: | Return value/description | Return type |
| getWorkName | Get work name of created work | string |
| Name: | Return value/description | Return type |
| setCompanyIdent | Set identifier of endpoint where | |
| | entry should be sent | |
| Parameter name: | Parameter description: | Parameter type |
| pIdent | endpoint identifier | identifier |
| Name: | Return value/description | Return type |
| setPeriod | Set period of time that should be | |
| | reserved | |
| Parameter name: | Parameter description: | Parameter type |
| pPeriod | time period to set | handle to Period object |
| Name: | Return value/description | Return type |
| setResourceIdent | Set identifier of resource for which | |
| | work should be created | |
| Parameter name: | Parameter description: | Parameter type |
| pIdent | resource identifier | identifier |
| Name: | Return value/description | Return type |
| setServiceIdent | Set identifier of service for which | |
| | work should be created | |
| Parameter name: | Parameter description: | Parameter type |
| pIdent | service identifier | identifier |
| Name: | Return value/description | Return type |
| setState | Set state to request. | |
| Parameter name: | Parameter description: | Parameter type |
| pState | new state | see getState for possible |
| | | values |
| Name: | Return value/description | Return type |
| setWorkIdent | Set identifier of work which should | |
| | be modified | |
| Parameter name: | Parameter description: | Parameter type |
| pIdent | work identifier | identifier |

2.38 ReservationListReply
Reply to ReservationListRequest

| | | |
|---|---|---|
| Name: | Return value/description | Return type |
| getItems | Get list of reservations | list of handles to Reservation |
| | | objects |

2.39 ReservationListRequest

| | | |
|---|---|---|
| Name: | Return value/description | Return type |
| setRange | Set time period for which | |
| | reservation list should be requested | |
| Parameter name: | Parameter description: | Parameter type |
| pIdent | work identifier | identifier |

2.40 ReservationReply
Reply to ReservationRequest

| | | |
|---|---|---|
| Name: | Return value/description | Return type |
| getReservationId | Get reservation identifier assigned | identifier |
| | by CNBURS | |
| Name: | Return value/description | Return type |
| getReservationCode | Get reservation auth code assigned | string |
| | by CNBURS | |
| Name: | Return value/description | Return type |
| getCompanyEntriesList | Get list of entries created by | list of handles to |
| | reservation request processing | CompanyEntries objects |

2.41 ReservationRequest
ReservationRequest is a request to CNBURS to cancel, modify or create new reservation
for one or more endpoints.

| | | |
|---|---|---|
| Name: | Return value/description | Return type |
| addEntry | Add reservation entry to request | |
| Parameter name: | Parameter description: | Parameter type |
| pEntry | entry data | handle to ReservationEntry |
| | | object |
| Name: | Return value/description | Return type |
| getVars | Get list of user defined variables | list of handles to Var objects |
| | tied to reservation | |
| Name: | Return value/description | Return type |
| setReservationId | Set existing reservation id. Used | |
| | for requests that should cancel or | |
| | modify existing reservations. | |
| Parameter name: | Parameter description: | Parameter type |
| pIdent | reservation identifier | identifier |
| Name: | Return value/description | Return type |
| setRequestType | If type is RR_INITIAL_BLOCK | |
| | then request will block time slots in | |
| | endpoints for short amount of time | |
| | needed for authorization. | |
| | Otherwise reservation object is | |
| | created or modified in endpoint | |
| Parameter name: | Parameter description: | Parameter type |
| pType | request type | constant one of: |
| | | RR_INITIAL_BLOCK: dont |
| | | do real reservation, just block |
| | | time for authorization |
| | | RR_FINAL: do final |
| | | reservation |
| | | RR_MODIFY_RESERVATION: |
| | | cancel reservation |
| Name: | Return value/description | Return type |
| setVars | Set list of variables tied to | |
| | reservation | |
| Parameter name: | Parameter description: | Parameter type |
| pVars | new list of variables | list of handles to Var objects |

2.42 ServiceReply
Reply to ServiceRequest.

| | | |
|---|---|---|
| Name: | Return value/description | Return type |
| getCompany | Get endpoint data where request | handle to Company object |
| | was sent | |
| Name: | Return value/description | Return type |
| getPeriodReplies | Get list of period data per endpoint | list of handles to PeriodReply |
| | | objects |

2.43 ServiceReplyMatch
Part of PeriodReply related to single Resource

| | | |
|---|---|---|
| Name: | Return value/description | Return type |
| getPeriods | get list of available time slots for | list of handles to Period |
| | resource | objects |
| Name: | Return value/description | Return type |
| getResourceIdent | Get resource identifier that this | identifier |
| | object refers to | |
| Name: | Return value/description | Return type |
| getResourceName | Get resource name that this object | string |
| | refers to | |

2.44 ServiceRequest
Request to get list of resources with a list of available reservation periods from a single
endpoint

| | | |
|---|---|---|
| Name: | Return value/description | Return type |
| addPeriodQuery | Add new period query data to | |
| | request | |
| Parameter name: | Parameter description: | Parameter type |
| pQuery | query data | handle to PeriodQuery object |
| Name: | Return value/description | Return type |
| getCompanyIdent | Get endpoint identifier where | identifier |
| | request will be sent | |
| Name: | Return value/description | Return type |
| setCompanyIdent | Set endpoint identifier where | |
| | request will be sent | |
| Parameter name: | Parameter description: | Parameter type |
| pIdent | endpoint identifier | identifier |
| Name: | Return value/description | Return type |
| setServiceIdent | Set service identifier for which | |
| | request will be sent | |
| Parameter name: | Parameter description: | Parameter type |
| pIdent | service identifier | identifier |

The APIs may be specified in other manners, so as long as substantially equivalent functionality is provided.

A number of basic types may be used in the SAPI 162 and MAPI 152 specifications, including the following types:

(a) string—set of alphanumeric characters encoded in Unicode

(b) integer—integer value

(c) real—floating value

(d) datetime—represents an absolute moment in the time

(e) timespan—time interval

(f) handle—handle to object of given class

(g) bool—true or false

(h) list—list of basic or complex types.

The SAPI 162 and MAPI 152 specifications may also include complex types that have operations needed to access and process data.

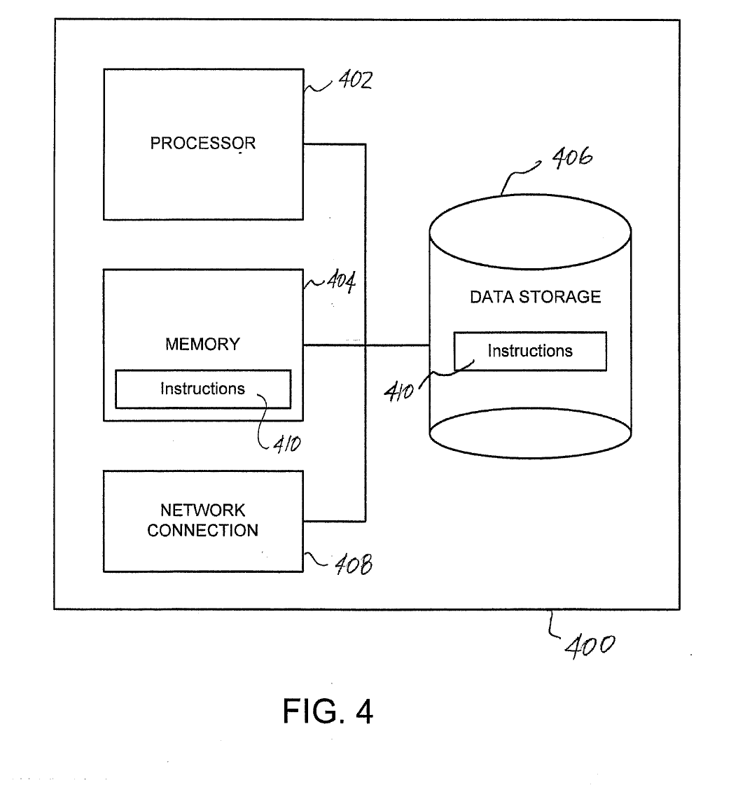

FIG. 4 depicts one embodiment of an exemplary computing system 400 that may be utilized to implement one or more of the various components of the CNBURS 100. For example, URPC 110, the service offering systems 130, and the marketplace systems 140 may be implemented using separate computing systems 400 such as depicted in FIG. 4. Computing system 400 depicted in FIG. 4 is not the only computing system architecture that be utilized to implement various components of CNBURS 100 and differently configured computing systems or the like may be utilized. Further, multiple computing systems 400 such as depicted in FIG. 4 may be utilized to implement a single component within the CNBURS 100.

Computing system 400 includes, among other components, a processor 402, memory 404, a data storage device 406 (e.g., a hard drive), and a network connection device 408 (e.g., an Ethernet card, a WiFi network card or the like). Computing system 400 may include additional components that are not illustrated in FIG. 2 including, for example, a power supply, an input device (e.g., a keyboard, a pointing device), and an output device (e.g., a display). The processor 402 executes computer program instructions 410 stored in memory 404 and/or on the data storage device 406 that enable the computing system 400 to provide the desired functionality of the component within the CNBURS 100 that computing system 400 is be used to implement.

The computer program instructions 410 may, for example in the case of computing system 400 being used to implement a URPC 110, include instructions enabling the computing system 400 to provide the various functionalities of the UPRC 110 including retrieving service offers 132 from a service offering systems 130, providing the offers 132 to marketplace systems 140, accepting reservation requests 146 from marketplace systems 140, passing the requests 146 to the appropriate service offering systems 130, and providing a results back to the appropriate marketplace systems 140 via the computer network(s) 120 using its network connection device 408, as well as maintaining a copy of the retrieved offers 132 in its memory 404 and/or data storage device 406.

The computer program instructions 410 may, for example in the case of computing system 400 being used to implement a service offering system 130, include instructions enabling the computer system 400 to provide the various functionalities of the service offering system 130 including implementation of the service interface broker 160 and related SAPI 162 thereby enabling the exchange of information between the UPRC 110 and the service offering system 130 via the computer network(s) 120 using its network connection device 408.

The computer program instructions 410 may, for example in the case of computing system 400 being used to implement a marketplace system 140, include instructions enabling the computer system 400 to provide the various functionalities of the marketplace system 140 including implementation of the marketplace interface broker 150 and related MAPI 152 thereby enabling the exchange of information between the UPRC 110 and the marketplace system 140 via the computer network(s) 120 using its network connection device 408.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A computer network based universal reservation system enabling one or more clients to schedule reservations for services provided by one or more service providers, said system comprising:
a universal reservation processing center, said universal reservation processing center being enabled to receive one or more service offers, wherein the service offers are defined by the service offer providers;
one or more service offering systems, each said service offering system enabling service offer providers to define one or more service offers, wherein a service offer includes information indicating whether said universal reservation processing center is delegated authority to complete reservation requests with clients relating to the service offer; and
one or more marketplace systems, each said marketplace system being enabled to receive the one or more service offers from said universal reservation processing center, present the clients the one or more service offers, receive reservation requests from the clients relating to the one or more service offers, and communicate received reservation requests to said universal reservation processing center;
wherein said universal reservation processing center communicates the one or more service offers from said one or more service offering systems to said one or more marketplace systems; and
wherein said universal reservation processing center processes reservation requests received from said one or more marketplace systems.

2. The system of claim 1 further comprising:
one or more service interface brokers, each said service interface broker corresponding with one of said service offering systems and being enabled to connect said corresponding service offering system with said universal reservation processing center for communication there between via a computer network.

3. The system of claim 2 further comprising:
an API interfacing each said corresponding service interface broker and service offering system.

4. The system of claim 3 wherein at least one API comprises a software component incorporated in a service offering system.

5. The system of claim 3 wherein at least one API comprises a standalone computer program controlled by a service offering system connected therewith through a computer network.

6. The system of claim 1 further comprising:
one or more marketplace interface brokers, each said marketplace interface broker corresponding with one of said one or more marketplace systems and being enabled to connect said corresponding marketplace system with said universal reservation processing center for communication there between via a computer network.

7. The system of claim 6 further comprising:
an API interfacing each said corresponding marketplace interface broker and marketplace system.

8. The system of claim 7 wherein at least one API comprises a software component incorporated in a marketplace system.

9. The system of claim 7 wherein at least one API comprises a standalone computer program controlled by a marketplace system connected therewith through a computer network.

10. The system of claim 1 further comprising:
at least one media interface providing at least one-way communication from said one or more marketplace systems to the clients, wherein the service offers are communicated from said one or more marketplace systems to the clients via said at least one media interface.

11. The system of claim 10 wherein said at least one media interface provides two-way communication between said one or more marketplace systems and the clients, wherein the reservation requests are communicated from the clients to said one or more marketplace systems via the same said at least one media interface.

12. The system of claim 10 further comprising:
at least one additional media interface providing at least return channel communication from the clients to said one or more marketplace systems, wherein the reservation requests are communicated from the clients to said one or more marketplace systems via said at least one additional media interface.

13. The system of claim 1 further comprising:
at least one media interface enabling two-way communication between said one or more service offering systems and the service providers, wherein the at least one media interface enables operation of said one or more service offering systems by the service providers to define service offers.

14. The system of claim 1 wherein the service providers directly control operation of said one or more service offering systems to define service offers.

15. The system of claim 1 wherein said universal reservation processing center completes reservation requests received from said one or more marketplace systems for service offers including information indicating that said universal reservation processing center is delegated authority to complete reservation requests.

16. The system of claim 1 wherein at least one service offer includes information indicating that said universal reservation processing center is not delegated authority to complete reservation requests relating thereto, and wherein said universal reservation processing center informs the service providers about the reservation requests for which said universal reservation processing center is not delegated authority to complete through said one or more service offering systems.

17. The system of claim 1 wherein said universal reservation processing center, said one or more service offering systems, and said one or more marketplace systems each comprise a separate computer processor and software code separately executable by said separate computer processors.

18. The system of claim 17 wherein said separate computer processors comprising said universal reservation processing center and said one or more service offering systems are connectable via a computer network, and wherein said separate computer processors comprising said universal reservation processing center and said one or more marketplace systems are connectable via a computer network.

19. The system of claim 1 wherein said system includes only a single universal reservation processing center communicating service offers from a plurality of service offering systems to a plurality of marketplace systems and processing reservation requests received from said plurality of marketplace systems.

20. The system of claim 1 wherein said universal reservation processing center is implemented as a centralized computing system.

21. The system of claim 1 wherein said universal reservation processing center is implemented as a distributed computing system.

22. A computer network based universal reservation system enabling one or more clients to schedule reservations for services provided by one or more service providers, said system comprising:
a service offering system that defines a service offer by a service provider;
a universal reservation processing center that receives the service offer;
a service interface broker corresponding with said service offering system, wherein said service interface broker connects said corresponding service offering system with said universal reservation processing center for communication there between via a computer network;
an API interfacing said corresponding service interface broker and service offering system; and
a plurality of marketplace systems, wherein each said marketplace system receives the service offer from said universal reservation processing center, presents the clients the service offer, receives reservation requests from the clients relating to the service offer, and communicates received reservation requests to said universal reservation processing center;
wherein said universal reservation processing center communicates the service offer from said service offering system to said marketplace systems; and
wherein said universal reservation processing center processes reservation requests received from said marketplace systems.

23. The system of claim 22 wherein said API comprises a software component incorporated in the service offering system.

24. The system of claim 22 wherein said API comprises a standalone computer program controlled by the service offering system connected therewith through a computer network.

25. The system of claim 22 wherein the service offer includes information indicating whether said universal reservation processing center is delegated authority to complete reservation requests with clients relating to the service offer.

26. The system of claim 25 wherein the service offer includes information indicating that said universal reservation processing center is not delegated authority to complete reservation requests relating thereto, and wherein said universal reservation processing center informs the service provider about the reservation requests through said service offering system.

27. A computer network based universal reservation system enabling one or more clients to schedule reservations for services provided by one or more service providers, said system comprising:
a plurality of service offering systems that define one or more service offers by one or more service providers;
a universal reservation processing center that receives the one or more service offers;
a marketplace system that receives the one or more service offers from said universal reservation processing center, presents a client the one or more service offers, receives a reservation request from the client relating to the one or more service offers, and communicates the received reservation request to said universal reservation processing center;
a marketplace interface broker corresponding with said marketplace system that connects said corresponding marketplace system with said universal reservation processing center for communication there between via a computer network; and
an API interfacing the corresponding marketplace interface broker and marketplace system;
wherein said universal reservation processing center communicates the one or more service offers from said service offering systems to said marketplace system; and
wherein said universal reservation processing center processes the reservation request received from said marketplace system.

28. The system of claim 27 wherein said API comprises a software component incorporated in the marketplace system.

29. The system of claim 27 wherein said API comprises a standalone computer program controlled by the marketplace system connected therewith through a computer network.

30. The system of claim 27 wherein each service offer includes information indicating whether said universal reservation processing center is delegated authority to complete a reservation request with the client relating to the service offer.

31. The system of claim 30 wherein a service offer includes information indicating that said universal reservation processing center is not delegated authority to complete a reservation request relating thereto, and wherein said universal reservation processing center informs the service provider about the reservation request through said one or more service offering systems.
